(19) United States
(12) Patent Application Publication
(10) Pub. No.: US 2018/0020522 A1
(43) Pub. Date: Jan. 18, 2018

(54) Light Maintenance System

(71) Applicant: Thomas R. Rogers, III, Boston, MA (US)

(72) Inventor: Thomas R. Rogers, III, Boston, MA (US)

(21) Appl. No.: 15/649,371

(22) Filed: Jul. 13, 2017

Related U.S. Application Data
(60) Provisional application No. 62/362,389, filed on Jul. 14, 2016.

(51) Int. Cl. H05B 33/08; H05B 37/02; H05B 37/03

(52) U.S. Cl. CPC H05B 33/0866; H05B 37/038; H05B 37/0245; F21K 9/20; H05B 33/0863; F21K 9/65; H05B 33/089

(57) ABSTRACT

Lighting systems maintain the quantitative and/or qualitative output of a light as the light ages, while also limiting the power consumed by the light, for example by increasing this power limit as the light ages. Some lighting systems compensate for reduction of spectral output as the light ages by activating compensating light emitting diodes within a light, which compensating light emitting diodes produce a spectral output that supplements the light's output at the frequencies at which spectrum has been reduced. Some lighting systems cap the total power of consumed by the light even when compensating for loss of spectral output.

### PRIORITY

The present application claims priority from U.S. provisional application Ser. No. 62/362,389, filed Jul. 14, 2016, entitled “Light Maintenance System” and naming Thomas Raymond Rogers III as inventor, the disclosure of which is incorporated herein by reference in its entirety.

### TECHNICAL FIELD

The present invention relates to lighting systems, and more particularly to control of LED lighting systems.

### BACKGROUND ART

LED (light emitting diode) lighting is quickly emerging as the choice for the future of artificial lighting across the globe. LED lighting uses less energy than many lighting technologies in a wide variety of applications, and the controllability of LED lighting allows for even more energy savings through conservation by using automated controls to keep lights on only when they are in use. Many other lighting technologies cannot be turned off and on, or have the levels adjusted, without having negative effects on the lighting systems' components (ballasts and bulbs).

Consequently, there is a push from organizations like the Department of Energy (DOE) and electric utility commissions around the country and world to retrofit existing buildings with LED lighting. Building codes are even being changed to limit the possible use of other lighting technologies, by calling for multiple control technologies on each light, and requiring strict lighting energy intensities (watts/square foot) with energy codes like California's Title 24. Many bulb technologies cannot meet these requirements because, for example, they cannot be turned off and on in the maximum 15 minutes that is allowed by Title 24 for an unoccupied space. This limitation often voids the warranty of the ballasts in those systems. Other technologies cannot dim as often without putting stress on the system. This makes LED technology well suited for these applications.

However, the light output of a light emitting diode (“LED”) changes quantitatively (e.g., “lumen depreciation,” a reduction in the amount of light output for a given amount of power consumed by the LED) and/or qualitatively (e.g., “chromaticity shift” or “spectral shift,” a change spectral characteristics of the light output) as the LED ages. When such LEDs are on, the heat generated by the light production inside the LED package begins to degrade the materials that make up the diode and in turn diminish the quantity and or quality of light generated by the LED.

Moreover, although pricing is decreasing, LED lighting currently is significantly more expensive than many competing lighting options, so it requires consumers to evaluate energy savings and benefits over a given length of time. The lifetime of an LED is one of its most celebrated benefits—with some manufacturers promoting lifetimes of 10+years. If someone projects the electrical savings they will expect for this lifetime, it becomes a much more attractive decision to spend sometimes two to three times the upfront costs for LED lighting compared to other bulb technologies. The LEDs typically last longer and the bulbs are more of a disposable system. With the lack of maintenance changing bulbs and ballasts comes additional cost savings for LED, which, in some applications, can be greater than electric bill savings.

Lighting systems advertised and sometimes promised as “lifetime” do not tell the whole story. While a lighting fixture or lamp/LED module may not experience catastrophic failure in the advertised lifetimes marketed by manufacturers, the light delivered to the space is not the same throughout that time due to lumen depreciation and/or spectral shifting from the first day they are turned on. As noted above, when an LED is on, it generates heat that degrades the materials that make up the diode, consequently degrading the quantity of light generated by the LED, and also potentially changes the Correlated Color Temperature (CCT) of the light delivered. Different CCT (color) light can have different physiological and psychological effects that, if the light color is changing over time, were not intended by the initial lighting design. This can have safety, health, and production ramifications for inhabitants of the lighted space.

### SUMMARY OF VARIOUS EMBODIMENTS

In accordance with one embodiment, a lighting system has a lighting fixture with 1) an inherent decreasing light output that diminishes with time at constant power and 2) a power input for controlling the light output, and a controller operably coupled with the power input of the lighting fixture. The controller is configured both to maintain a changeable power cap to the power input and increase the power cap to increase power to the power input. The increase in the power cap causes the lighting fixture to increase light output. Preferably, this increase in the power cap is a function of the inherent decreasing light output of the lighting fixture over time.

The lighting system also may have a light sensor configured to receive the light output of the lighting fixture to detect the inherent decreasing light output. In that case, the light sensor may be configured to produce a light signal having information relating to the inherent decreasing light output of the lighting fixture. In a corresponding manner, the controller is configured to increase the power cap as a function of the light signal. Alternatively or in addition, the controller may be configured to increase the power cap according to a prescribed timing pattern that is a function of the inherent decreasing light output of the lighting fixture. For example, the timing pattern may be a function of the usage age of the lighting fixture.

The increase in the power cap preferably is a function of a specified light output of the lighting fixture. For example, the increase in the power cap may maintain the light output of the lighting fixture to within ten percent of the specified light output. Some embodiments also have a user power control operably coupled with the power input. As its name suggests, the user power control permits a user to control light output of the lighting fixture. However, the controller is configured to maintain the light output at an amount that does not exceed the specified light output—the user cannot exceed the specified light output.

In accordance with other embodiments of the invention, a lighting system has a lighting fixture with a plurality of primary LEDs and a plurality of compensation LEDs. The primary LEDs have a specified spectral output with an inherent diminishing spectral output. The system also has a controller operably coupled with the lighting fixture. The controller is configured to selectively activate at least one of the compensation LEDs to produce a combined spectral output of the primary LEDs and the at least one compensation LED. This selective activation of the at least one compensation LED is made a function of the inherent diminishing spectral output of the plurality of primary LEDs and the specified spectral output.

The combined spectral output is considered to have a combined inherent diminishing spectral output. Accordingly, the controller is configured to activate at least one additional compensation LED as a function of the combined inherent diminishing spectral output and the specified spectral output.

In some embodiments, the lighting fixture has a fixture spectral output and the system further includes a spectrum sensor positioned to sense the fixture spectral output. In that case, the spectrum sensor is operably coupled with the controller, which is configured to activate the at least one compensation LED in response to the fixture spectral output detected by the spectrum sensor. The controller may activate a plurality of compensation LEDs. For example, the controller may be configured to activate one or more additional compensation LEDs in response to the fixture spectral output detected by the spectrum sensor—after the at least one compensation LED is activated.

Alternatively or in addition, the controller may be configured to activate the at least one compensation LED according to a prescribed timing pattern that is a function of the inherent decreasing diminishing spectral output of the lighting fixture. Among other things, the timing pattern may be a function of the age of the lighting fixture

The controller may be configured to activate the at least one compensation LED to maintain the combined spectral output of the primary LEDs and at least one compensation LED to within ten percent of the specified spectral output. Moreover, the controller may be configured to deactivate or dim one or more primary LEDs as or after it activates the at least one compensation LED to maintain a cap on total power consumption of the lighting fixture

In accordance with another embodiment, a system limits power consumption by a lighting fixture, while maintaining a performance of the lighting fixture over a length of time. To that end, the system includes:

a lighting fixture; and

a controller operably coupled to the lighting fixture, the controller configured to raise, as the lighting fixture ages, a limit on the maximum power consumed by the lighting fixture, so as to substantially maintain a constant level of light output as the lighting fixture ages.

In general, the system limits the ability of an end user to raise the power limit. However, at a point in time, the power consumed by the lighting fixture may be reduced by a user, even though it may not be increased by the user beyond the limit in effect at that point in time. For example, the user may turn the lighting fixture on and off at will, and/or may dim, or brighten, the lighting fixture at will, but always subject to the limit in effect at that point in time.

In another embodiment, a method for limiting power consumption by a lighting fixture, while maintaining a performance of the lighting fixture over a length of time, includes:

providing a lighting fixture;

establishing a limit on the maximum power consumed by the lighting fixture; and

raising, as the lighting fixture ages, the limit on the maximum power consumed by the lighting fixture, so as to maintain a substantially constant level of light output as the lighting fixture ages.

In some embodiments, raising the limit on the maximum power consumed by the lighting fixture includes receiving, from a full authority lighting manager, data indicating a new limit. Raising the limit on the maximum power consumed by the lighting fixture may involve, in various embodiments, raising the limit in response to both the age of the lighting fixture and/or the cumulative output of a light sensor. In other embodiments, raising the limit on the maximum power consumed by the lighting fixture includes raising the limit according to a pre-established schedule as a function of the age of the lighting fixture. In yet other embodiments, raising the limit on the maximum power consumed by the lighting fixture includes raising the limit according to a pre-established schedule as a function of the age of the lighting fixture but not in response to output of a light sensor.

An embodiment of another system for compensating for diminished spectral output of a lighting fixture, while maintaining a cap on the lighting fixture's power consumption, includes:

a lighting fixture having a plurality of primary LEDs and a plurality of compensation LEDs,

the primary LEDs producing an initial spectral output when the primary LEDs are new, but producing diminished spectral output as the lighting fixture ages, and

the compensation LEDs producing, when active, a compensating spectral output at frequencies at which the initial spectral output has diminished with age; and

a controller operably coupled to the lighting fixture to activate one or more compensation LEDs as the lighting fixture ages, to compensate for the diminished spectral output of the primary LEDs.

Some embodiments also include a spectrum sensor disposed to sense the spectral output of the lighting fixture, and in communication with the controller, such that the controller activates one or more compensation LEDs in response to diminished spectral output as detected by the spectrum sensor.

In some embodiments, the controller activates compensation LEDs according to a pre-established schedule as a function of the age of the lighting fixture, but not in response to output of a spectrum sensor.

In preferred embodiments, the controller deactivates or dims one or more primary LEDs as it activates or brightens compensation LEDs, so as to maintain a cap on total power consumption of the lighting fixture.

In yet another embodiment, a method of compensating for diminished spectral output of a lighting fixture, while maintaining a cap on the lighting fixture's power consumption, includes:

providing a lighting fixture having a plurality of primary LEDs and a plurality of compensation LEDs,

the primary LEDs producing an initial spectral output when the primary LEDs are new, but producing diminished spectral output as the lighting fixture ages, and

the compensation LEDs producing, when active, a compensating spectral output at frequencies at which the initial spectral output has diminished with age; and

activating one or more compensation LEDs as the lighting fixture ages, to compensate for the diminished spectral output of the primary LEDs.

To that end, some embodiments include spectrum sensor disposed to sense the spectral output of the lighting fixture, the spectrum sensor in communication with the controller, such that the controller activates one or more compensation LEDs in response to diminished spectral output as detected by the spectrum sensor.

In some embodiments, the controller activates compensation LEDs according to a pre-established schedule as a function of the age of the lighting fixture, but not in response to output of a spectrum sensor. In yet other embodiments, wherein the controller deactivates one or more primary LEDs as it activates compensation LEDs, so as to maintain a cap on total power consumption of the lighting fixture.

### BRIEF DESCRIPTION OF THE DRAWINGS

The foregoing features of embodiments will be more readily understood by reference to the following detailed description, taken with reference to the accompanying drawings, in which:

FIG. 1 schematically illustrates an embodiment of a power limiting system;

FIG. 2A schematically illustrates an embodiment of a light fixture;

FIG. 2B schematically illustrates an embodiment of a system having multiple light fixtures;

FIG. 3 schematically illustrates an embodiment of a controller;

FIG. 4A is a flow chart for a method of power control;

FIG. 4B is a chart of an embodiment of power limit over time;

FIG. 5A is a flow chart for an embodiment of a method of spectral management;

FIGS. 5B-5D schematically illustrate embodiments of spectra, respectively, of light emitting diodes.

### DETAILED DESCRIPTION OF SPECIFIC EMBODIMENTS

Various embodiments improve the function, operation, and/or efficiency of light systems. A light system may include one or more light fixtures, each having one or more the light producing elements (e.g., light emitting diodes, etc.) and some light systems cap a light fixture's power consumption, while also maintaining the fixture's quantity and/or quality of light output.

For example, some embodiments establish a power limit/cap for the power consumption of the system, and/or a given light fixture within the system, and then increase the power limit as the light fixture ages, to compensate for the natural reduction of light output that occurs as a light emitting diode ages. Thus, the “power limit” is a controllable and variable limit on the power that may be consumed by a light fixture. A power limit applicable to a light fixture at a given point in time may be referred to as the “applicable” power limit at that point in time.

In illustrative embodiments, a light fixture's power limit is variable, and may be varied (e.g., increased) by a full authority lighting manager—not by an end user or other unauthorized user. A light fixture's power limit may be varied by a local feedback loop, a local controller (e.g., which increase the power limit as a function of the age of the light), or a remote controller (e.g., under the control of a full authority lighting manager). A power limit may be less than the power that is available and could be supplied to the light fixture. For example, a power source may be capable of supplying 100 watts of electrical power to a light fixture, but a power limit may prevent the power source from supplying more than 70 watts of electrical power to the light

In some embodiments, when increasing the power limit as a function of age, the full authority lighting manager may use the actual age of the fixture 200. For example, every two months, the power limit may be raised. In other embodiments, however, the age is based on the total usage of the fixture 200. Continuing with the above example, even if the fixture 200 is two months old, the power limit will remain the same. Instead, in this latter case, the power limit is raised based on the total time/usage of the LEDs of the fixture 200. Thus, in the noted example, the power would be increased after two months of actual use of the fixture 200—the total time the fixture 200 is producing light output. This actual use time for this and other embodiments may be referred to as the “usage age.”

More particularly, some embodiments allow an authorized user (e.g., a power utility, or the party that pays for power) to control the power limit, but prevent an unauthorized user from increasing that limit. In this way, the authorized user can control the maximum power consumed by the light fixture, while still maintaining light output quantity, and remaining assured that an unauthorized user does not override that limit. Some embodiments also allow an unauthorized user to turn the light fixture on and off, or to dim the light fixture output, while still prohibiting that unauthorized user from overriding the limit.

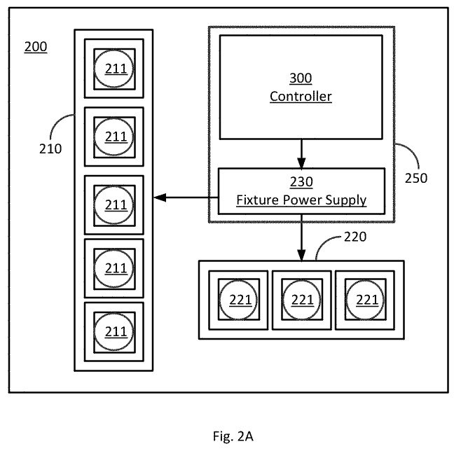

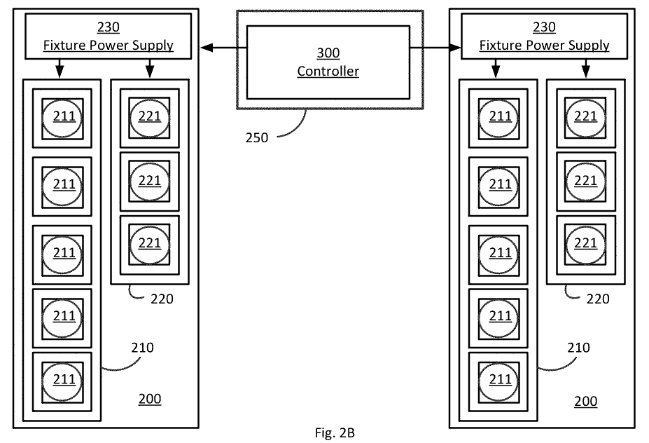

Some embodiments compensate for loss of spectrum (i.e., light quality) as the light fixture ages (e.g., usage age or actual age) by activating (turning on or brightening) additional light emitting diodes within a given light fixture. Such additional light emitting diodes, which may be referred to as “compensation LEDs,” have a spectral output that supplements, or complements, the light fixture's output in the spectrum (e.g., frequencies or wavelengths) at which the light fixture's spectrum has diminished. In some embodiments, the total power of consumed by the light fixture (including the compensation LEDs) remains capped by a power limit, even as the system compensates for spectral shifting. To that end, such embodiments may decrease the power supplied to a subset of the light emitting diodes within the light fixture. The reduction may be equal to the amount of power consumed by activated compensation LEDs. For example, with reference to FIG. 2A, as a compensation LED 221 is activated and draws power, power to a primary LED 211 may be reduced by that same amount, so that total power consumption those LEDs remains substantially constant. Similarly, if an LED e.g., a compensation LED 221 is already active and producing light, and power to that LED 221 is increased by a supplemental amount, then power to another LED e.g., a primary LED 211 may be reduced by that supplement amount, so that total power consumption those LEDs remains constant.

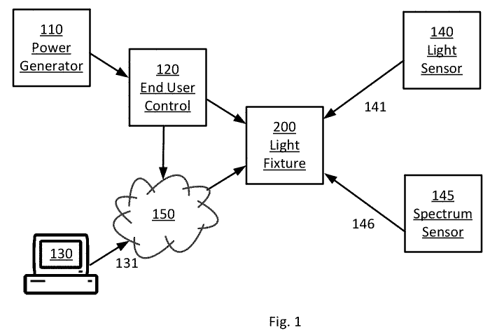

Consequently, various embodiments generally may allow an authorized user to cap a light fixture's power consumption, while maintaining quantity and/or quality of light output, and preventing an unauthorized user from increasing that limit. Details are discussed below with reference to FIGS. 1-5D.

FIG. 1 schematically illustrates a power limiting system for a light fixture 200. The light fixture 200 may be configured to be secured to a building (e.g., a ceiling or wall), pole, or other structure. As additional examples, the light fixture 200 may also be part of a floor lamp, table lamp, or other lamp not configured to be secured to a structure.

The light fixture 200 receives electrical power from a power generator 110. As known by those in the art, the power generator 110 may be a power company's power plant, a solar array, a local electrical generator, or a storage device such as a battery, to name but a few examples. In some embodiments, such as when the power generator 110 is a battery, the power generator 110 may even be an integral part of the fixture 200.

An end user of the fixture 200, such as the owner of the fixture 200, or a person responsible for operating the fixture 200, may exert some control over the operation of the fixture 200 by using an end user control 120. In illustrative embodiments, the end user control 120 is electrically disposed between the power generator 110 and the fixture 200, and allows an end user to operate the fixture 200. As an example, the end user control 120 may be a binary light switch (on/off) that in an “on” state connects the fixture 200 to the power from the power generator 110, and in an “off” state disconnects the fixture 200 from that power. Alternately, the end user control 120 may be a conventional dimmer switch, a timer, or a combination of both. The end user control 120 may also be an electronic device like a smart phone or tablet that allows the end user to exert some control over the fixture 200 (e.g., on; off; dim) through a network 150 in communication with the electronic device and the fixture 200.

Various embodiments described herein manage one or more aspects of the performance of the light fixture 200.

Quantitative Management—Power Consumption; Light Quantity

The system of FIG. 1 also includes a full authority lighting manager 130 in communication with the fixture 200.

Function

As described herein, the full authority lighting manager 130 establishes and manages one or more limits on the amount power that the fixture 200 is allowed to consume, while also mitigating the effects of diminished light output as the fixture 200 ages. More particularly, some embodiments allow the full authority lighting manager 130 (e.g., a lighting manufacturer, a power utility, or the party that pays for power) to control the power limit, but prevent an unauthorized user (e.g., an end user of a light fixture 200, such as a property owner, or tenant) from increasing that limit. In this way, the full authority lighting manager 130 can control the maximum power consumed by the light fixture 200, while still maintaining light output quantity, and remaining assured that an unauthorized user does not override that limit. Some embodiments also allow an end user to turn the light fixture 200 on and off, or to dim the light fixture output, while still prohibiting that unauthorized user from overriding the limit.

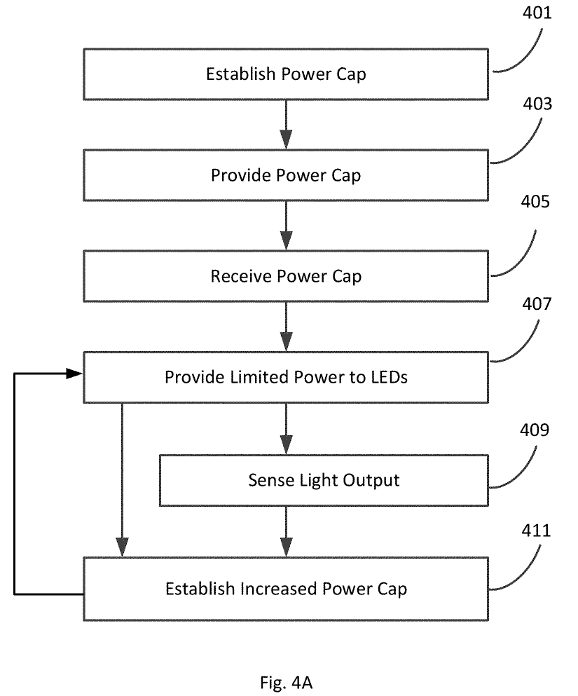

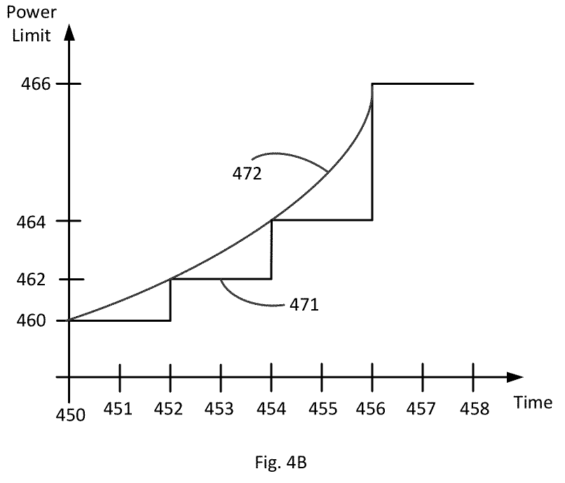

The flow chart of FIG. 4A provides an illustrative embodiment of a method of managing such power limits, and the graph of FIG. 4B illustrates power limit increases over time. It should be noted that this method may be considered to be simplified from a longer process that normally would be used. Accordingly, the method may have additional steps that those skilled in the art may use. In addition, some of the steps may be performed in a different order than that shown, or at the same time. Those skilled in the art therefore can modify the process as appropriate.

The process begins at step 401, in which the full authority lighting manager 130 establishes an initial limit, which may be referred to as a power cap or power limit. In FIG. 4B, this may occur at time 450, and the initial power cap may be at power level 460. This power cap, which is controllable and variable, is set as a function of the inherent decreasing light output of the lighting fixture 200 over time. Specifically, the lighting fixture 200 has the above noted inherent decreasing light output that diminishes with time at constant power. In other words, for a given power, over time, the light output of the lighting fixture 200 diminishes. In a similar manner, the lighting fixture 200 also has an inherent decreasing or diminishing spectral output over time. Illustrative embodiments aim to mitigate those problems.

With regard to lumen/light depreciation, the fixture 200 in some embodiments may be “over-engineered,” such that it is able to “dim up” (brighten) over time as its light output degrades with age (i.e., the total usage of the fixture 200), for example, due to heat. If an LED 211 is expected or specified to lose 28% of its light production over its lifetime (i.e., its inherent decreasing light output), some embodiments build the light fixture 200 to be able to at least deliver 128+% of its initial designed lighting levels, and initially dim down from total capacity, and over time dim up to deliver the designed lighting levels throughout the system's projected or warrantied lifetime (e.g., 5 years; 10 years, etc.). If the light degrades 3% per year, for example, such systems dim up 3% plus any additional amount necessary to account for diminished system efficacy. Even though the total fixture possible wattage draw could be 135 watts, such embodiments govern the possible wattage draw to 100 watts for the initial operational period (before site light measurements are taken).

The initial power cap 460 may be determined by, for example, a specification of the fixture 200, statue or regulation, or by contract such as a power contract between a power utility and a customer. For example, the fixture 200 may have a specified light output of X lumens. Therefore, the initial power cap should be sufficient to produce “X” lumens for the given fixture 200. As noted above, if this power is maintained constant, eventually the given fixture 200 will produce a light output that is lower than “X” lumens.

The full authority lighting manager 130 communicates the initial power cap to the fixture 200 at step 403, for example by sending the initial power cap in a message 131 to the fixture 200 over a network 150. If the full authority lighting manager 130 is not remote from the fixture 200, then the method may omit this step.

The fixture 200 includes a controller 300 that receives the message 131 from the authority lighting manager 130 at step 405. If the full authority lighting manager 130 is not remote from the fixture 200, then the method omits this step.

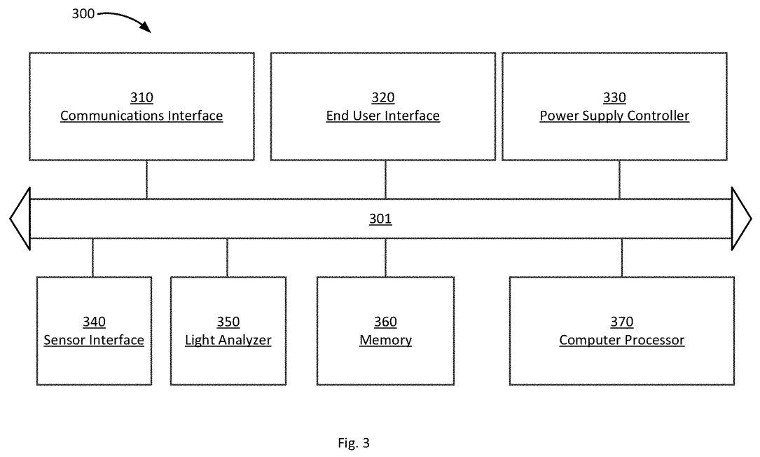

The controller 300 includes several components 310-370, embodiments of which are described below with regard to FIG. 3. Each component may communicate with each other component over bus 301. Indeed, it should be noted that FIG. 3 only schematically shows each of these components. Those skilled in the art should understand that each of these components can be implemented in a variety of conventional manners, such as by using hardware, software, or a combination of hardware and software, across one or more other functional components. For example, the communications interface 310 may be implemented using a plurality of microprocessors executing firmware. As another example, the communications interface 310 may be implemented using one or more application specific integrated circuits (i.e., “ASICs”) and related software, or a combination of ASICs, discrete electronic components (e.g., transistors), and microprocessors. Accordingly, the representation of the communications interface 310 and other components in a single box of FIG. 3 is for simplicity purposes only. In fact, in some embodiments, the communications interface 310 of FIG. 3 is distributed across a plurality of different machines—not necessarily within the same housing or chassis.

It should be reiterated that the representation of FIG. 3 (as well as other figures, such as FIGS. 2A and 2B) is a significantly simplified representation of an actual controller 300. Those skilled in the art should understand that such a device has many other physical and functional components, such as central processing units, other packet processing modules, and short-term memory. Accordingly, this discussion is in no way intended to suggest that FIG. 3 represents all of the elements of the controller 300.

Among other things, the controller 300 includes the above noted communications interface 310, which is in operable communication with the network 150. The communications interface 310 forwards the message 131 to a computer processor 370 (part of the controller 300), which analyzes the message 131 and provides instructions to a power supply controller 330. In some embodiments, the light fixture 200 includes a connection to a “node” (which may also be referred to as a port) operably coupled to, or part of, the communications interface 310 of controller 300. The node may be, for example, a USB port, or a wireless interface, such as an interface using the Bluetooth protocol for example. Such a node allows a person, such a field technician installing or maintaining the light fixture 200, to communicate with the controller 300 to operate or test the fixture 200, to extract data stored in the fixture's memory 360, and/or adjust performance parameters of the fixture 200 (e.g., power limit; pre-programmed increases to the power limit; decreasing or resetting a power limit, etc.)

At step 407, the power supply controller 330, in turn, controls the fixture's power supply 230 according to the instructions from the computer processor 330, to provide limited power a primary LED bank 210 of the fixture 200 (FIGS. 2A and 2B, discussed below). For example, the fixture's power supply 230 may have a power input that receives a signal from the power supply controller 330 to control the power the power supply 230 produces (i.e., the power cap).

In preferred embodiments, the power supply 230 is not a power generator. Instead, it is a circuit configured to regulate the application of power from a power source 110 to the primary LED bank 210 and, as described below in some embodiments, to compensation LED bank 220 (also in FIGS. 2A and 2B). A fixture designer may specify the form of the output of the power supply 230, which may be a controlled AC voltage, a controlled DC voltage, a pulse-width modulated (“PWM”), or a controlled current, to name but a few examples. As an example, the power supply 230 may include a digitally programmable regulator as known in the art, or a digital-to-analog converter (“ADC”) with either a voltage output or a current output. The output of the digitally programmable regulator or ADC may be controlled, for example, by signals from the controller 300.

The primary LED bank 210 produces light using power from the power generator 110. Indeed, this power consumed by the LEDs 211 of the LED bank 210 does not exceed (is prohibited from exceeding) the initial power level 460. It should be noted that the limited power 460 is less than the maximum power available from the power generator 110, and also less than the maximum power that LEDs 211 would consume if coupled directly to the power generator, such as through a binary switch in the “on” configuration.

In illustrative embodiments, an end user operating the end user control 120 may turn the light from the fixture 200 on and off, dim the light, or increase the light. In no case (in those embodiments), however, can the end user increase the power limit, or cause the fixture 200 to use power in excess of the power limit. It should also be noted that the power limiting system of that embodiment (e.g., controller 300 and power supply 230) differs from a prior art dimmer switch, at least in that a dimmer switch is accessible to and operable by an end user to adjust lighting level as desired, whereas illustrative embodiments of power limiting systems are not accessible to and/or are not operable by an end user. Alternative embodiments may permit user control. The controller 300 ensures that the light output does not exceed the specified light output of the fixture 200—regardless of the input from the user.

As noted above, over time, the light output by the LED bank 210 declines in a process known as “lumen depreciation” (a reduction in the amount of light output for a given amount of power consumed by a LED). This phenomenon undesirably causes the quantity of light output by the fixture 200 to decline. To compensate for lumen depreciation, in illustrative embodiments, the full authority light manager 130 increases the power limit and communicates this increase to the light fixture 200 at step 411. In some embodiments, a process of raising the power limit includes receiving, from the full authority lighting manager 130, data indicating a new limit that is greater than the initial limit or then-current limit. This limit preferably is a function of the inherent decreasing light output of the fixture 200 over time. In preferred embodiments, this increasing power limit returns the light output to an amount specified for the fixture 200, thus also increasing the power cap as a function of the specified light output (e.g., to within about ten percent of the specified light output, and preferably to within about one percent of the specified light output).

To that end, in some embodiments, raising the power limit includes raising the power limit as a function of one or both the age of the lighting fixture 200 and the output of a light sensor that senses the quantity and/or quality of the light output. FIG. 1 schematically shows this light sensor as two boxes—light sensor 140 and spectrum sensor 145. Yet other embodiments raise the limit according to a pre-established schedule (i.e., a timing pattern) as a function of the age of the lighting fixture 200. It should be noted that the amount and frequency of raised limits based on fixture age are a function of the inherent diminishing/decreasing light quality (i.e., diminished light output and/or color). For example, a person and/or logic at a utility may have knowledge of the inherent light and/or color diminution over time (at a constant a power) of the lighting fixture 200. That person/logic then may use that information to determine the amount of each increase and frequency of those increases. The controller 300 then may control the lighting fixture 200 using those requirements (e.g., using a formula).

In a similar manner, various embodiments that raise the power limit in response to information (e.g., received via a signal) from the light sensor 140 also are considered to increase the power cap as a function of the inherent decreasing light output because the sensor 140 detects that inherent decreasing light output—it detects that inherent quality. Thus, the light sensor 140 generates a signal that it forwards to the controller 300 for modifying the power cap.

Another embodiment raises the power limit in response to output of the light sensor 140—not as a function of the age of the lighting fixture 200.

As an example, at time 452 in FIG. 4B, the power limit may be raised to level 462, and so forth at later times as illustrated. In some embodiments, the power limit is raised in a step-wise manner in discrete amounts and/or at discrete times, as shown by curve 471. In other embodiments, however, the power limit may be raised continuously or near-continuously, as shown by curve 472. Yet other embodiments may raise the power limit in a continuous manner at some times, and discretely at other times.

In response to the raised power limit (e.g., 462 in this example), having looped back to step 407, the controller 300 revises its control of the fixture's power supply 230 according to the instructions from the computer processor 330, to provide more power (but still limited power) to the primary LED bank 210 of the fixture 200. With each increase in the power limit, the light output by the fixture 200 increases, preferably back to its original light output level.

It should be noted that, in some embodiments time may be measured as the chronological age of the fixture 200 regardless of the use of the fixture 200. In such embodiments, for example, time 450 in FIG. 4B may represent a newly manufactured fixture 200, and time 452 may represent the second anniversary of that manufacture, and time 454 may represent the fourth anniversary of that manufacture, etc.

In other embodiments, time may be the total amount of time that the fixture 200 has been used to produce light regardless of its chronological age. In such embodiments, for example, time 450 in FIG. 4B may represent a newly manufactured fixture 200, and time 452 may represent 200 hours of cumulative use of the fixture 200 to produce light, and time 454 may represent 400 hours of cumulative use of the fixture 200 to produce light, etc. Of course, the times mentioned above are merely for illustrative purposes, and are not limitations on the various embodiments described herein. Actual times may depend on other factors, such as the lumen depreciation properties of the LEDs 211 in the fixture 200, and/or heat dissipation properties of the fixture 200 and/or the conditions in which the fixture 200 is operated, to name but a few examples.

Closed-Loop Operation

Some embodiments implement a closed-loop operation for limiting the power consumption of the fixture 200. To that end, some embodiments are configured to be coupled to, or include, a light quantity sensor 140 configured to receive light produced by the fixture 200 at optional step 409 in the flow chart in FIG. 4A. The light quantity sensor 140 may be a quantum or photon counting sensor; a radiometer; a photodiode; a photo transistor; a photoresistor; a photovoltaic cell; or charge coupled device, to name but a few examples.

The sensor 140 produces a signal to indicate the quantity of light received and provides that signal to a light analyzer 350—which is part of the controller 300. The light analyzer 350 assesses the quantity of light against a quantity of light output specified for or desired from the fixture 200. For example, the light analyzer 350 may digitize the signal and compare it to a standard stored in memory 360.

If the quantity of light does not meet the standard, then the controller 300 controls the power supply 230 to provide more power to the LEDs 211; 221, but still subject to the applicable power limit.

Prevent Tampering

To prevent tampering, such as by an end user seeking to override a power limit, the full authority lighting manager 130 may be separate from the end user and thus, not accessible to or controllable by the end user. In illustrative embodiments, the full authority lighting manager 130 is remote from the fixture 200 to be physically inaccessible by a potential tamperer. As an example, the full authority lighting manager 130 may be located at a power company facility distant from the fixture 200, or in another place not accessible to the end user.

In other embodiments, the full authority lighting manager 130, or portions thereof, may be part of the fixture 200, but not accessible to the end user. For example, one or more components of the full authority lighting manager 130, and/or other components of the fixture 200 used to implement a power limit, may be implemented in integrated circuits that, for all practical concerns, are beyond the ability of a tamperer to access or change. Alternately, or in addition, the full authority lighting manager 130, and/or other components of the fixture 200 used to implement a power limit, may be physically protected against tampering by a housing 250, to name but a few examples.

As a further example, the system may be protected against tampering by encrypting communication between the full authority lighting manager 130 and fixture 200 so that a prospective tamperer could not imitate the full authority lighting manager 130. To that end, the full authority lighting manager 130 may send a message to the fixture 200 using an authentication protocol. Upon receipt of the message, the fixture 200 can confirm that the message is from the full authority lighting manager 130, rather than from a protective tamperer.

Qualitative Management—Light Quality

Some embodiments also or alternatively compensate for spectral shift, while still limiting power consumption as described above. To that end, some systems include the noted spectrum sensor 145 configured to receive light produced by the fixture 200. Indeed, some embodiments of the fixture 200 include such a spectrum sensor 145. The spectrum sensor 145 is sensitive to at least the wavelengths of light for which the output of the fixture 200 may degrade over time, and preferably for all wavelengths of light produced by the fixture 200 when it is new.

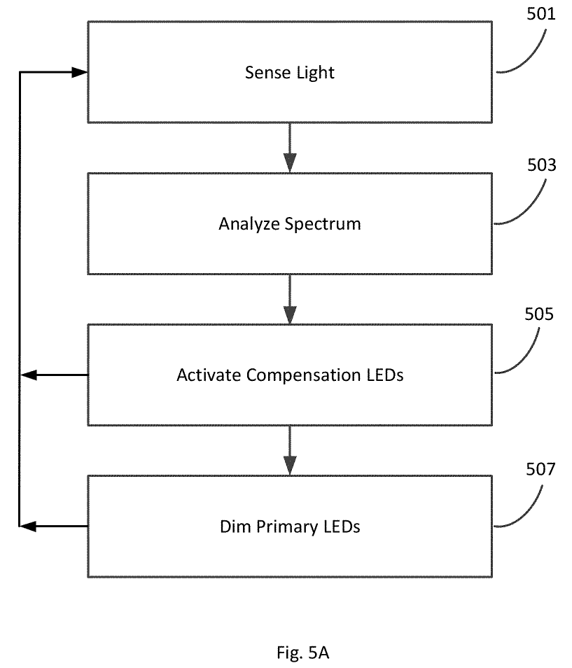

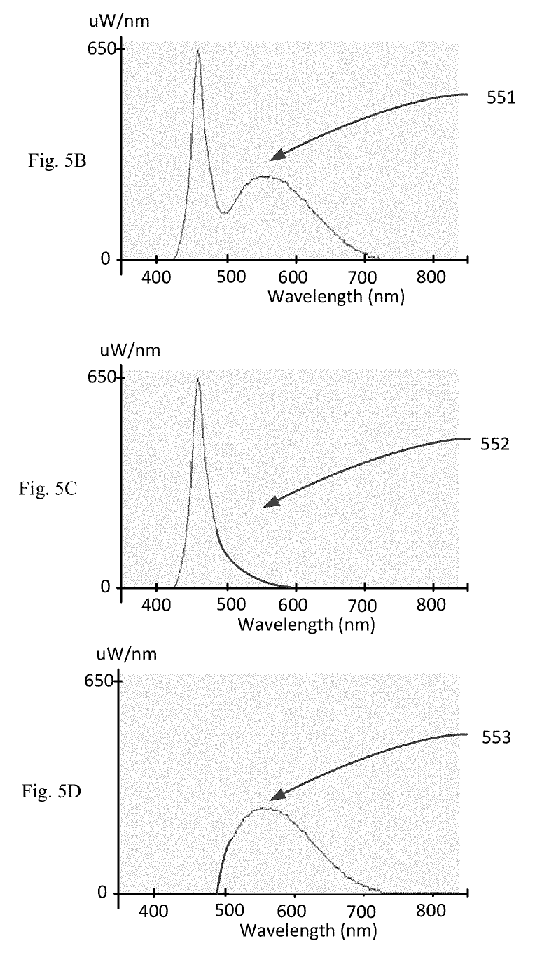

A method of compensating spectral shift is illustrated by the flow chart in FIG. 5A. In a manner to the prior discussed method, this method may be considered to be simplified from a longer process that normally would be used. Accordingly, the method may have additional steps that those skilled in the art may use. In addition, some of the steps may be performed in a different order than that shown, or at the same time. Those skilled in the art therefore can modify the process as appropriate.

At step 501, the spectral sensor 145 senses light produced by the fixture 200. The spectral sensor 145 is in communication with the controller 300 by a sensor interface 340 (FIG. 3), which is configured to receive a signal 141 from the sensor 145. The sensor interface 340 provides signals from the sensor 145 to the light analyzer 350 for analysis. For example, the sensor interface 340 may include an analog-to-digital converter to convert a signal from the sensor 145 into a digital format, and then provide the digitized signal to the light analyzer 350 over the bus 301.

The light analyzer 350 analyzes the spectral content of the sensor's signal at step 503, and quantifies that spectral content (e.g., frequency components and their amplitudes) to determine how much of the spectral content has been lost and desirably could be replaced. For example, the light analyzer 350 may have a digital signal process circuit (“DSP”) configured to perform a Fourier transform on the sensor's signal 141 to determine its spectral content. Moreover, the light analyzer 350 may compare the spectral content of the sensor signal 141 (frequency components and their amplitudes) to the known or desired spectral content (frequency components and their amplitudes) of the output of the fixture 200 stored in memory 360 (FIG. 3), so as to detect and quantify spectral shift.

To illustrate the problem of spectral shift, the curve 551 of FIG. 5B schematically illustrates the spectral output of a new primary LED 211. As shown in that figure, the spectral output of a new primary LED 211 has a peak at a wavelength of about 475 nm, and a smaller peak at about 560 nm. In contrast, FIG. 5C schematically illustrates the spectral output of that same primary LED 211 at a later time. As shown the curve 552 in FIG. 5C, its spectral output has largely retained the peak at 475 nm, but has largely lost its output at wavelengths above about 500 nm. Various embodiments do not require a complete loss of such a portion of the spectrum, however, and can compensate for spectrum that is merely diminished and not yet completely lost. The spectral shift of the primary LED 211 may be detected as, and quantified by, the difference between the spectrum of FIG. 5B and the spectrum of FIG. 5C.

To compensate for spectral shift, some embodiments of the fixture 200 include the prior noted compensation LEDs 221 (FIGS. 2A and 2B) in addition to the primary LEDs 211. The compensation LEDs 221 controllably produce a spectrum different from, and in preferred embodiments complementary to, the original or desired spectrum of the primary LED 211 in that the spectral output of a compensation LED 221 includes or is limited to wavelengths lost by the spectral output of the primary LED 211 over time.

In keeping with the example from FIG. 5B and FIG. 5C, to at least partially compensate for this loss of output spectrum, the compensation LEDs 221 have spectral output at wavelengths above about 500 nm, as schematically illustrated by the curve 553 in FIG. 5D. Preferably, the light output of the compensation LED has the same amplitude (here expressed in μW/nm) as that the primary LED 211 originally had in that portion of the spectrum.

When one or more compensation LEDs 221 are activated, their output supplements the output of primary LED's 211 so that the spectral output of the fixture 200 retains both portions of the spectrum. In other words, the spectrum of FIG. 5C and the spectrum of FIG. 5D together approximate the spectrum of FIG. 5B. Accordingly, the one or more compensation LEDs 221 are activated as a function of the inherent diminishing spectral output of the plurality of primary LEDs 211 and the specified spectral output of the fixture 200. Note that at this point, the inherent diminishing spectral output of the fixture 200 includes the primary LEDs 211 and the output of the recently activated compensation LEDs 221. Accordingly, subsequent compensation LEDs 221 may be activated at later times using the same process—which includes use of the compensation LEDs 221 (the combined inherent diminishing spectral output of both types of LEDs 211 and 221).

To that end, at step 505, the controller 300 controls and adjusts the power provided to one or more of the compensation LEDs 221 to adjust the amount of their compensatory light. For example, if a portion of a primary LED's spectrum is completely lost (e.g., FIG. 5C), then some embodiments activate one or more compensation LEDs 221 at full output. However, if a portion of a primary LED's spectrum is merely diminished, then some embodiments may activate one or more compensation LEDs 221 at less than the full available output of those compensation LEDs 221 to produce compensating light proportional to the diminution of the primary LED's spectrum. Such operation of primary LEDs 211 and compensation LEDs 221 may be described as a redistribution of power within the LEDs (211; 221) and not merely an off/on adjustment of primary LEDs 211 and/or compensation LEDs 221. The method then loops back to step 501, to sense and re-evaluate the light subsequently produced by the fixture 200. As a result, the spectrum of the light output by the fixture 200 is adjusted so that it substantially matches its previous or original spectrum 551. For example, the spectrum of the light output may be within ten percent of the specified spectral output (preferably within one percent).

Other embodiments may activate one or more compensation LEDs 221 as the fixture 200 ages. To that end, with knowledge of the inherent decreasing diminishing spectral output of the fixture 200, as well as the specified spectral output, logic or a person may set a timing pattern to automatically activate one or more of the compensation LEDs 221 as the fixture 200 ages.

Optionally, at step 507, some embodiments also reduce power to the primary LEDs 211 after providing or increasing power to one or more compensation LEDs 221. This maintains the total power consumed by the fixture 200 below a power limit in place at that time. In other words, in some embodiments, the total power consumed by the light fixture 200 (including the compensation LEDs 221) remains capped by a power limit, even as the system compensates for spectral shifting. To that end, such embodiments may decrease the power supplied to a subset of the light emitting diodes (e.g., primary LEDs 211) of the light fixture 200. The reduction to such a subset may be equal to the amount of power consumed by activated compensation LEDs 221. For example, as one of the compensation LEDs (221) is activated and draws an amount of power, power to one of the primary LEDs (211) may be reduced by that same amount so that total power consumption those LEDs remains constant. Similarly, if an LED (e.g., one of the compensation LEDs 221) is already active and producing light, and power to that LED (221) is increased by a supplemental amount, then power to another LED (e.g., one of the primary LEDs 211) may be reduced by that supplement amount so that total power consumption those LEDs (211 and 221) remains constant, or at least so that the total power consumed by the light fixture 200 remains at or below the applicable power limit.

Multiple Fixture Embodiments

FIG. 2B schematically illustrates and embodiment of a multiple fixture light system in which multiple fixtures 200 are controlled by a single controller 300. In such an embodiment, where a single controller 300 controls a plurality of fixtures 200, the controller 300 may be referred to as control “hub” or “controls hub.” In this embodiment, each fixture 200 may have its own power supply 230 in communication with the controller 300. The controller 300 controls each power supply 230 independently in the ways described above for both lumen depreciation and/or spectral shift. Such an embodiment may be desirable, for example, in a large facility, such as factory or office building in which the total power consumed by all of the fixtures 200 in the system are to be controlled.

Although illustrative embodiments show compensation LEDs 221 in the same fixture 200 as primary LEDs 211, such integration is not necessary. Rather, in some embodiments, compensation LEDs 221 are mounted in a separate fixture 200 located near a fixture 200 housing primary LEDs. Such fixture 200 may be referred to as a “compensation fixture.” A compensation fixture may include a spectral sensor 145 and operate as described herein to activate and control compensation LEDs 221. Other embodiments may mount some LEDs 221 in a separate compensation fixture, and other LEDs 221 in the local fixture 200 (with the primary LEDs 211).

In some embodiments, the LEDs 211 and/or 221 are individually addressable, in that the power supply 230 may control individual LEDs 211 and/or 221, rather than apply the same power or control to all LEDs 211, 221 in a bank 210 and/or 220. To that end, fixtures 200 in some embodiments include integrated circuit (IC) chips in tandem with LEDs 211; 221, so that the individual LEDs 211 and 221 are addressable and may thereby be controlled in a group or any combination of individual diodes 211 and 221 as desired for light error correction.

Moreover, some embodiments of LED banks 210, 220 include integrated circuit switching chips configured to controllably (e.g., under control of the controller 300) change the number of LEDs 211, 221 in a string during a power line cycle so that the voltage of the LED string matches the instantaneous power line voltage.

Implementation Examples

Because the actual lighting levels of activity areas can be so important for productivity, safety, and health, in the beginning of installing and managing light maintenance systems, some embodiments use sensors to gather data, and have software that organizes and presents data to lighting managers on a digital screen interface (e.g., a tablet, monitor, phone, controls device, controller 300).

In some embodiments, field technicians may measure and adjust to determine the correct current to “drive” the LED power source (which may be referred to as an “initial level”), and thus adjust the LED fixture's total light output. A field technician may also establish or set a light fixture's power limit. Through the Internet of Things (IoT) platform, some embodiments gather and organize data from site visits by field technicians to gather sensor data and have available in Building Management Systems (BMS) and Energy Management Systems (EMS) to building engineers, and/or to collect this data to analyze for future pre-programmed models.

Field technicians connect a sensor 140 and/or 145 to a single fixture 200 through a “node” integrated into or wired to the fixture 200. To connect the sensor 140 and/or 145 to a group of fixtures 200, the field technician connects the sensor 140 and/or 145 to the “communications hub.” The node and hub allow the fixture 200 to be controlled beyond the simple functions of the end users' capabilities, such as on/off/dim. The field technician gets light levels from the sensor 140 and/or 145, reads them on digital screen interface (tablet) and regulates the current that the LED power sources are operating at through the digital screen computer based device (tablet, phone, etc.). Data is saved for the facility profile to analyze for future visits and determine the rate of depreciation moving forward.

Feedback (or “Closed-Loop) Embodiments

Some embodiments account for lighting output losses and chromaticity shifting by, for example, monitoring lighting delivered, and adjusting lighting levels while blocking end users from overriding governed operational lighting system parameters (e.g., power limits).

For example, to know that a fixture 200 delivers substantially the precise lighting that was designed for a given space, some embodiments measure the light produced by the fixture 200 and make changes to maintain the designed lighting levels. For example, some embodiments use one or more sensors 140 and/or 145 that measure the lighting levels (e.g., a light intensity sensor) and/or spectrum (e.g., a spectrum sensor 145). These levels can be compared to pre-populated building-specific data, for example data in memory 360 processed by the computer processor 370, and can automatically correct lighting levels according to: initial levels minus present lighting levels at the time of sensor data collection.

In an illustrative embodiment, if a light fixture's output started at 100 lumens, and later has an output of 97 lumens, the power (e.g., current (amperage) and/or voltage) at which the power source 230 “drives” the primary LEDs 211 may be adjusted upwardly to raise light output to the original 100 lumens maximum capacity. Software stored in a computer memory 360 and executing on a computer processor 370 (e.g., or, alternately, memory and a microprocessor in an external personal computer, tablet, smartphone, etc.) determines the appropriate adjusted voltage/ amperage for the power sources (230), and then controls or adjusts the maximum voltage and/or amperage output by the power source (230) to deliver the specified lighting levels for end user. Alternatively, portions of the software may be accessible using cloud computing concepts.

Open-Loop Embodiments

Other embodiments do not use a sensor 140 or implement a feedback model. Rather, such embodiments include pre-programmed lighting (e.g., stored in memory 360) to maintain the level of light output by a light fixture 200. For example, in some embodiments, software stored in memory 360 and executed on computer processor 370 calculates and adjusts the electrical current to the designed light levels for the space, with or without data from a light intensity sensor 140, or field technician assistance.

If the quantitative or qualitative light output of a light fixture 200 degrades linearly, or at predictable rate, some embodiments include a more programmed approach to lower lighting power consumption and management costs. Designers of the light fixture 200 may collect data at a proposed light fixture installation site to identify predictable and reliable light patterns. Such site visits are a part of providing desired lighting levels for more productive, safer, and healthier inhabitants. That collected data may then be used to program increases in power limits at pre-specified times.

Various embodiments offer end users complete transparency when choosing the best lighting for their building and applications, and deliver long-lasting, as-designed lighting. With the control of the LEDs 211 and/or 221, users can adjust the color or (CCT) of the lights if they wish. They can install motion sensors, photocells for “daylighting” strategies, timers, or any other type of controls they wish. Various embodiments work similarly to other lighting systems in many respects, except the end user will have additional output initially that will not be accessible to them and potentially color adjustment. Each project is different and some users may be more concerned with color, while others may be concerned with total light output. Various embodiments address at least one of these two issues, and some embodiments and can address both.

Illustrative embodiments are shown and described using LEDs 211 and 221 as the light producing elements. The use of LEDs 211 and 221 has certain advantages. For example, the LEDs 211 and 221 may be dimmed and turned off and on without negatively affect its light production capability. Other technologies degrade with on and off cycling, and can also experience lower efficacy when dimmed, where the LEDs 211 and 221 can have improved efficacy at lower currents.

Nevertheless, the use of LEDs 211 and 221 as the light producing elements is not a limitation on all embodiments. For example, in other embodiments, some or all of the light producing elements could be, or include, lights of the following kinds: fluorescent lamps; metal halide lamps; ceramic metal halide lamps; high pressure sodium lamps; low pressure sodium lamps; light emitting plasma; sulfur plasma; halogen; incandescent lamps; compact fluorescent bulbs; induction lamps; mercury vapor lamps; and sulfur lamps.

Moreover, the light (which may be referred to as “electromagnetic radiation”) produced by light producing elements is not limited to visible light. Some applications, such as the indoor growth of crops, or killing bacteria, or the curing of epoxies, need wavelengths of light that are not necessarily visible to the human eye. For example, light output by a LED may include ultraviolet (“UV”) radiation, infrared (“IR”) radiation, and other frequencies and wavelengths, including without limitation wavelengths from 1 nm to 1,000 nm, or anywhere within that range, and any subsets of that range. Consequently, examples of specific wavelengths, frequencies or spectra of light do not limit this disclosure to visible light, or to light producing elements, light fixtures, systems and methods for producing and controlling light that is visible to a human.

In some embodiments described herein that compensate for lumen depreciation and/or spectral shift, it may be impossible or impractical for systems and methods to exactly replace lost lumens photon for photon, and/or to exactly replace lost spectrum. Consequently, it should be understood that mitigating or replacing lost lumens or spectra means substantially replacing lost lumens or spectra. In this context, the term “substantially” may mean replacing lost lumens or spectra to a degree that renders the output of a light fixture 200 or a system of such fixtures suitable for a desired, intended or specified application, as assessed by a person of ordinary skill in the art of such fixtures, or the application to which such fixtures are put. For example, to a farmer growing indoor plants, substantially replacing lost lumens and/or spectra means replacing lost lumens and/or spectra to a degree that the light output of the fixture 200 meets the specification or needs of the farmer for growing the indoor plants.

The following list includes reference numbers used herein:

110: Power generator;

120: End user light controller;

130: Full authority controller;

131: Message from controller to fixture;

140: Light quantity sensor;

141: Light quantity sensor output signal;

145: Spectrum sensor;

146: Spectrum sensor output signal;

150: Network;

200: Light fixture;

210: Primary LED bank;

211: Primary LED;

220: Compensation LED bank;

221: Compensation LED;

230: Fixture power supply;

250: Fixture controller housing;

300: Controller;

301: Bus;

310: Communications interface;

320: End user interface;

330: Fixture power supply controller;

340: Sensor interface;

350: Light analyzer;

360: Memory;

370: Computer processor;

450-458: Times;

460-466: Power levels;

471: Stepwise power limit increase;

472: Power limit increase curve;

551: Light spectrum of new primary LED;

552: Light spectrum of aged primary LED;

553: Light spectrum of compensation LED.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed on a tangible medium, such as a non-transient computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A lighting system comprising:
a lighting fixture having an inherent decreasing light output that diminishes with time at constant power, the lighting fixture further having a power input for controlling the light output; and
a controller operably coupled with the power input of the lighting fixture, the controller being configured to maintain a changeable power cap to the power input, the controller being configured to increase the power cap to increase power to the power input, the increase in the power cap causing the lighting fixture to increase light output, the increase in the power cap being a function of the inherent decreasing light output of the lighting fixture over time.

2. The lighting system as defined by claim 1 further comprising a light sensor configured to receive the light output of the lighting fixture to detect the inherent decreasing light output, the light sensor configured to produce a light signal having information relating to the inherent decreasing light output of the lighting fixture, the controller configured to increase the power cap as a function of the light signal.

3. The lighting system as defined by claim 1 wherein the controller is configured to increase the power cap according to a prescribed timing pattern, the prescribed timing pattern being a function of the inherent decreasing light output of the lighting fixture.

4. The lighting system as defined by claim 3 wherein the timing pattern is a function of the usage age of the lighting fixture.

5. The lighting system as defined by claim 1 wherein the lighting fixture includes an LED to produce the light output.

6. The lighting system as defined by claim 1 wherein the lighting fixture has a specified light output, the increase in the power cap being a function of the specified light output.

7. The lighting system as defined by claim 6 wherein the increase in the power cap maintains the light output of the lighting fixture to within ten percent of the specified light output.

8. The lighting system as defined by claim 6 further comprising a user power control operably coupled with the power input, the user power control permitting a user to control light output of the lighting fixture, the controller being configured to maintain the light output at an amount that does not exceed the specified light output.

9. A lighting system comprising:
a lighting fixture having a plurality of primary LEDs and a plurality of compensation LEDs, the primary LEDs having a specified spectral output, the spectral output of the primary LEDs having an inherent diminishing spectral output; and
a controller operably coupled with the lighting fixture, the controller being configured to selectively activate at least one of the compensation LEDs to produce a combined spectral output of the primary LEDs and the at least one compensation LED, the controller being configured to selectively activate the at least one compensation LED as a function of the inherent diminishing spectral output of the plurality of primary LEDs and the specified spectral output.

10. The lighting system as defined by claim 9 wherein the combined spectral output has a combined inherent diminishing spectral output, the controller being configured to activate at least one additional compensation LED as a function of the combined inherent diminishing spectral output and the specified spectral output.

11. The system as defined by claim 9 wherein the lighting fixture has a fixture spectral output, the system further comprising a spectrum sensor positioned to sense the fixture spectral output,
the spectrum sensor also being operably coupled with the controller, the controller being configured to activate the at least one compensation LED in response to the fixture spectral output detected by the spectrum sensor.

12. The system as defined by claim 11 wherein the controller is configured to activate one or more additional compensation LEDs in response to the fixture spectral output detected by the spectrum sensor.

13. The lighting system as defined by claim 9 wherein the controller is configured to activate the at least one compensation LED according to a prescribed timing pattern, the prescribed timing pattern being a function of the inherent decreasing diminishing spectral output of the lighting fixture.

14. The lighting system as defined by claim 13 wherein the timing pattern is a function of the age of the lighting fixture.

15. The lighting system as defined by claim 9 wherein the controller is configured to activate the at least one compensation LED to maintain the combined spectral output of the primary LEDs and at least one compensation LED to within ten percent of the specified spectral output.

16. The lighting system as defined by claim 15 wherein the controller is configured to deactivate or dim one or more primary LEDs as or after it activates the at least one compensation LED to maintain a cap on total power consumption of the lighting fixture.

17. A lighting system comprising:
a lighting fixture having a plurality of primary LEDs and a plurality of compensation LEDs, the primary LEDs having a specified spectral output, the spectral output of the primary LEDs having an inherent diminishing spectral output,
the lighting fixture also having an inherent decreasing light output that diminishes with time at constant power, the lighting fixture further having a power input for controlling the light output; and
a controller operably coupled with the lighting fixture, the controller being configured to selectively activate at least one of the compensation LEDs to produce a combined spectral output of the primary LEDs and the at least one compensation LED, the controller being configured to selectively activate the at least one compensation LED as a function of the inherent diminishing spectral output of the plurality of primary LEDs and the specified spectral output,
the controller also configured to maintain a changeable power cap to the power input and configured to increase the power cap to increase power to the power input, the increase in the power cap causing the lighting fixture to increase light output, the increase in the power cap being a function of the inherent decreasing light output of the lighting fixture over time.

18. The lighting system as defined by claim 17 further comprising a light sensor configured to receive the light output of the lighting fixture to detect the inherent decreasing light output, the light sensor configured to produce a light signal having information relating to the inherent decreasing light output of the lighting fixture, the controller configured to increase the power cap as a function of the light signal.

19. The lighting system as defined by claim 17 wherein the controller is configured to increase the power cap according to a prescribed timing pattern, the prescribed timing pattern being a function of the inherent decreasing light output of the lighting fixture, the age of the lighting fixture, or both the inherent decreasing light output of the lighting fixture and the age of the lighting fixture.

20. The lighting system as defined by claim 17 wherein the combined spectral output has a combined inherent diminishing spectral output, the controller being configured to activate at least one additional compensation LED as a function of the combined inherent diminishing spectral output and the specified spectral output.
